(19) United States
(12) Patent Application Publication
(10) Pub. No.: US 2010/0001978 A1
(43) Pub. Date: Jan. 7, 2010

(54) AMBIENT LIGHT INTERFERENCE REDUCTION FOR OPTICAL INPUT DEVICES

(76) Inventors: Stephen Brian Lynch, Portola Valley, CA (US); Steve porter Hotelling, San Jose, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/167,237

(22) Filed: Jul. 2, 2008

(51) Int. Cl. G06F 3/042

(52) U.S. Cl. 345/175

(57) ABSTRACT

Methods and apparatus for preventing fluctuations in ambient light from affecting the optical input mechanism of a liquid crystal display device. In one embodiment, an independent light source is adapted to generate electromagnetic signals through the cover glass of the display device. When the user's finger is proximate to a certain region of the touch panel, the electromagnetic signals reflect off of the user's finger and back through the cover glass. One or more photosensors monitoring the presence of these reflected signals service the various regions on the touch panel where input may be detected. Thus, when the reflected signals are detected at a certain region, the user's finger may be assumed to be present.

### FIELD OF THE INVENTION

The present invention relates generally to the field of optical input devices. More particularly, the present invention is directed in one exemplary aspect to reducing ambient light interference in liquid crystal display devices supporting optical input.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Some conventional touch screen devices utilize an array of capacitive sensors in order to detect surface contact at various locations of a touch sensor panel. In other devices, input is provided by an array of photosensors adapted to detect reductions in light at various regions behind the cover glass. For example, when a stylus is positioned proximate to the surface of the cover glass, ambient light is blocked at the position of the stylus. One or more shadows cast upon various photosensors subsequently trigger input to the touch screen device at the locations corresponding to where a decrease in light has been detected. In many cases, input to the touch screen device is triggered when the photosensors detect a decrease in light exceeding a certain threshold.

Problems can arise, however, when ambient light conditions vary as a function of time. This is because the photosensors cannot differentiate between a reduction in light associated with a specific input (for example, as caused by the shadow of a finger or stylus) and a reduction in light associated with changes in the surrounding environment (for example, as caused by an office light being shut off). In this respect, variations in the amount of ambient light interfere with the optical input mechanism of the touch screen device.

The problems presented by ambient light interference are not trivial. In some cases, changes in ambient light cause false inputs to be generated. In other cases, changes in ambient light prevent subsequent input from being detected, thereby resulting in a non-operational state. Additionally, a high volume of optical input devices are affected by this phenomenon since many such devices are adapted for use in environments exhibiting variable light conditions.

### SUMMARY OF THE INVENTION

Various embodiments of the present invention are directed to preventing fluctuations in ambient light from affecting the optical input mechanism of a liquid crystal display device. In conventional optical-in-liquid-crystal-display devices, an array of photosensors is adapted to detect the specific regions of the touch panel where light has been blocked. For example, if a user's finger is situated proximate to the upper right portion of a touch panel, ambient light will no longer reach the photosensors in that particular region. The shadow from the user's finger may be detected by the photosensors as a decrease in light. In this manner, the photosensors indicate which regions of the touch panel have been “touched” (i.e. shaded) by the user's finger.

However, the photosensors are not able to readily distinguish between decreases in light associated with a user's specific input and decreases in light occurring from changing environmental conditions. Various embodiments of the present invention therefore address this problem by providing an independent light source that is adapted to generate electromagnetic signals through the cover glass of the display device. When the user's finger is proximate to a certain region of the touch panel, the electromagnetic signals reflect off of the user's finger and back through the cover glass. One or more photosensors monitoring the presence of these reflected signals service the various regions on the touch panel where input may be detected. Thus, when the reflected signals are detected at a certain region, the user's finger may be assumed to be present. In this manner, input to the optical device can be properly detected despite variations in ambient lighting.

### BRIEF DESCRIPTION OF THE DRAWINGS

FIG. 1 is a block diagram illustrating an exemplary optical-in-liquid-crystal-display device comprising a light source situated within the backlight assembly according to one embodiment of the present invention.

FIG. 2A is a circuit diagram illustrating exemplary logic for modulating LED current amplitude according to one embodiment of the present invention.

FIG. 2B is a circuit diagram illustrating exemplary logic for processing received signals 206 according to the embodiment depicted by FIG. 2A.

FIG. 3 is a circuit diagram illustrating exemplary demodulation logic according to one embodiment of the present invention.

FIG. 4 is a circuit diagram illustrating exemplary demodulation logic according to another embodiment of the present invention.

FIG. 5 is a block diagram illustrating an exemplary optical-in-liquid-display device comprising a light source situated adjacent to a cover glass according to one embodiment of the present invention.

FIG. 6 is a block diagram illustrating an exemplary optical-in-liquid-crystal-display device adapted to detect force input according to one embodiment of the present invention.

FIG. 7 is a block diagram illustrating an exemplary optical-in-liquid-crystal-display device adapted to detect capacitive input according to one embodiment of the present invention.

FIG. 8 is a flow diagram illustrating an exemplary method of determining input from received signals according to one embodiment of the present invention.

FIG. 9 is a flow diagram illustrating an exemplary method of sampling photosensors according to one embodiment of the present invention.

FIG. 10 is a flow diagram illustrating an exemplary method of determining input from optical readings and contact readings according to one embodiment of the present invention.

FIG. 11 is a flow diagram illustrating an exemplary method of optimizing power in an input device adapted to detect generated signals according to one embodiment of the present invention.

FIG. 12 is a block diagram illustrating an exemplary computing system according to one embodiment of the present invention.

FIG. 13A is a graphical illustration of an exemplary mobile telephone comprising a photosensor array according to one embodiment of the present invention.

FIG. 13B is a graphical illustration of an exemplary digital media player comprising a photosensor array according to one embodiment of the present invention.

FIG. 13C is a graphical illustration of an exemplary personal computer comprising a photosensor array according to one embodiment of the present invention.

### DETAILED DESCRIPTION OF THE PREFERRED EMBODIMENTS

In the following description of preferred embodiments, reference is made to the accompanying drawings in which it is shown by way of illustration specific embodiments in which the invention can be practiced. It is to be understood that other embodiments can be used and structural changes can be made without departing from the scope of the embodiments of this invention.

Various embodiments of the present invention are directed to preventing fluctuations in ambient light from affecting the optical input mechanism of a liquid crystal display device. In conventional optical-in-liquid-crystal-display devices, an array of photosensors is adapted to detect the specific regions of the touch panel where light has been blocked. For example, if a user's finger is situated proximate to the upper right portion of a touch panel, ambient light will no longer reach the photosensors in that particular region. The shadow from the user's finger may be detected by the photosensors as a decrease in light. In this manner, the photosensors indicate which regions of the touch panel have been “touched” (i.e. shaded) by the user's finger.

However, the photosensors are not able to readily distinguish between decreases in light associated with a user's specific input and decreases in light occurring from changing environmental conditions. Various embodiments of the present invention therefore address this problem by providing an independent light source that is adapted to generate electromagnetic signals through the cover glass of the display device. When the user's finger is proximate to a certain region of the touch panel, the electromagnetic signals reflect off of the user's finger and back through the cover glass. One or more photosensors monitoring the presence of these reflected signals service the various regions on the touch panel where input may be detected. Thus, when the reflected signals are detected at a certain region, the user's finger may be assumed to be present. In this manner, input to the optical device can be properly detected despite variations in ambient lighting.

Although embodiments of the invention may be described and illustrated herein in terms of optical-in-liquid-crystal-display devices, it should be understood that embodiments of this invention are not so limited, but are additionally applicable to any optically driven computer or input device. Furthermore, although embodiments of the invention may be described and illustrated herein in terms of being optically driven, this is not to be taken in an exclusive sense. The optical input may be provided in combination with any other form or type of input, including, without limitation, capacitive sensing and force detection.

As used herein, the term “application” includes without limitation any unit of executable software which implements a specific functionality or theme. The unit of executable software may run in a predetermined environment; for example, a downloadable Java Xlet™ that runs within the JavaTV™ environment.

As used herein, the terms “computer program” and “software” include without limitation any sequence of human or machine cognizable steps that are adapted to be processed by a computer. Such may be rendered in any programming language or environment including, for example, C/C++, Fortran, COBOL, PASCAL, Perl, Prolog, assembly language, scripting languages, markup languages (e.g., HTML, SGML, XML, VoXML), functional languages (e.g., APL, Erlang, Haskell, Lisp, ML, F# and Scheme), as well as object-oriented environments such as the Common Object Request Broker Architecture (CORBA), Java™ (including J2ME, Java Beans, etc.).

As used herein, the term “display” includes any type of device adapted to display information, including without limitation cathode ray tube displays (CRTs), liquid crystal displays (LCDs), thin film transistor displays (TFTs), digital light processor displays (DLPs), plasma displays, light emitting diodes (LEDs) or diode arrays, incandescent devices, and fluorescent devices. Display devices also include less dynamic devices such as printers, e-ink devices and other similar structures.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “processor,” “microprocessor,” and “digital processor” include all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs). Such processors may be contained on a single unitary IC die or distributed across multiple components.

As used herein, the term “network” refers generally to any type of telecommunications or data network including, without limitation, cable networks, satellite networks, optical networks, cellular networks, and bus networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, hybrid fiber coaxial, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “wireless” refers to any wireless signal, data, communication, or other interface including, without limitation, Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IRDA).

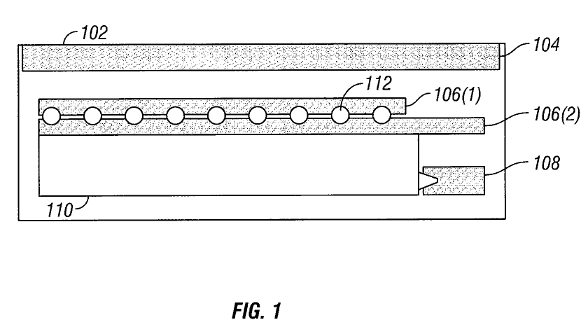

FIG. 1 is a block diagram illustrating an exemplary optical-in-liquid-crystal-display device 102 including a light source 108 situated within the backlight assembly according to one embodiment of the present invention. As shown by the figure, the light source 108 is adapted to generate electromagnetic signals from within the display device 102. One or more lightguides 110 may be used to direct, position, control, manipulate, and/or reflect the electromagnetic signals such that they pass through the cover glass 104 of the display device 102. Such lightguides 110 include, without limitation, rectangular, dielectric slab, and/or optical fiber waveguides (e.g., planar, strip, or fiber devices). Note also that even though FIG. 1 depicts the lightguides 110 as being situated within the backlight assembly of the display device 102, the lightguides may be positioned and/or oriented in any location relative to the light source 108 according to embodiments of the present invention.

In some embodiments, the electromagnetic signals are selected and/or modulated such that they are distinguishable from ambient light signals. For example, in some embodiments, the electromagnetic signals have a different wavelength than the wavelength of ambient or ordinary light. In other embodiments, the electromagnetic signals are periodically broken, generated in pulses, blinked, or otherwise interleaved with another signal in order to accomplish this effect.

According to some embodiments, the light source 108 includes one or more light emitting diodes (LEDs), at least a portion of which operate independently from the light source driving the liquid crystal display device 102. The light emitting diodes of the light source 108 may be of the same or of a different type. For example, in one embodiment, the light source 108 includes a combination of infrared and white LEDs. Additionally, the light emitting diodes may include any combination of inorganic semiconductor materials. This includes, without limitation, aluminum gallium arsenide, aluminum nitride, aluminum gallium nitride, and aluminum gallium indium nitride.

In some embodiments, the electromagnetic signals generated by the light source 108 pass through a display structure before penetrating the cover glass 104 of the display device 102. In some embodiments, the display structure includes a layer of liquid crystal molecules (not shown) housed between two plates of thin-film transistor glass 106(1) and 106(2). The liquid crystal layer includes a plurality of liquid crystal structures each positioned between transparent electrodes in a helical or twisted arrangement. The liquid crystal structures are adapted to rotate the polarization of incident light as a function of the voltage applied between the surrounding electrodes. Thus, by varying the voltage associated with each pixel, various levels of gray can be produced (or in the case of color, various combinations of red, green, and blue).

In some embodiments, one or more photosensors 112 are adapted to detect electromagnetic signals that have reflected back through the cover glass 104. This would occur, for example, if a finger, stylus or other such pointing instrument was positioned proximate to the cover glass 104 in the transmission path of the projected electromagnetic signals. In some embodiments, the one or more photosensors 112 provide input to the display device 102 as a function of expected angles of reflection. In some of these embodiments, the input may be based in part upon the position of the photosensors 112 and the angles at which light passes through the cover glass 104 before reflection.

In some embodiments, the one or more photosensors 112 are situated between the two plates of thin-film transistor glass 106(1) and 106(2). In some embodiments, the photosensors are oriented so as to minimize exposure to electromagnetic signals passing through the display structure (i.e., before reflection). Additionally, the photosensors 112 may be positioned in any pattern, configuration or arrangement according to embodiments of the present invention. This includes, for example, grid, staggered arrangements, interleaved arrangements, circular and semi-spherical arrangements, and arrangements including multiple layers. According to some embodiments, the one or more photosensors 112 are manufactured as a component of the thin film transistor glass 106(1) and 106(2).

In some embodiments, the photosensors 112 include one or more photodetectors capable of converting light into current and/or voltage. The photosensors 112 may include photodiodes (i.e. PN junctions or PIN structures) or other types of light sensors. This includes, without limitation, optical detectors, photoresistors, chemical detectors (e.g., photographic plates), photovoltaic cells, and/or phototransistors.

In some embodiments, optical input is determined exclusively by the photosensors 112. In this respect, input to the display device 102 may be determined by the electromagnetic signals generated by the light source 108, and not by the ambient light signals. In other embodiments, input to the display device 102 may be determined by detection of a combination of ambient light signals and the electromagnetic signals generated by the light source 108. Note also that in some embodiments, the photosensors 112 are adapted to detect both the electromagnetic signals generated by the light source 108 as well as ambient light signals. In other embodiments, a separate set of sensors may be used to detect ambient light signals.

In some of the embodiments where input to the display device 102 is based upon both the electromagnetic signals generated by the light source 108 and the ambient light signals (or the absence thereof), one or more weighting functions may be used to calibrate the significance of each respective factor utilized in an input determination process. In some embodiments, an ambient threshold is calculated when the level of ambient light detected is approximately uniform across the array of photosensors 112. In one embodiment, the amount of weight applied to the ambient component of the input determination process may be based upon the difference between the value of ambient light detected and the value of the calculated threshold.

The components of the input determination process may also be weighted according to other factors as well. For example, in some embodiments, power to the light source 108 and/or photodiodes 112 may be toggled based upon detected levels of ambient light. When ambient light levels are independently sufficient to permit detection of an object proximate to the cover glass 104 of the display device 102, the light source 108 and/or photodiodes 112 may be powered off, thereby preserving power. In some embodiments, this determination may be conducted at the sensor sampling frequency. After the light source 108 and/or photodiodes 112 have been powered off, the weight assigned to detected electromagnetic signals may be correspondingly readjusted.

In some embodiments, the photosensors 112 are adapted to demodulate modulated electromagnetic signals. As stated above, the electromagnetic signals may have different wavelengths and/or frequencies than those associated with ambient light. In one embodiment, for example, infrared light may be modulated in the 20 KHz-1 MHZ range, resulting in a system that is first order insensitive to ambient light conditions. Any module or mechanism adapted to recover the information content from the carrier wave may be used for demodulation according to embodiments of the present invention.

In some embodiments, the received photodiode current is demodulated by the same frequency of modulation at a constant phase. The resulting demodulated current signal is then free of spurious noise sources that are at DC (fixed) or at any frequency other than the modulation frequency. In this manner, spurious environmental light noise may be rejected by the system.

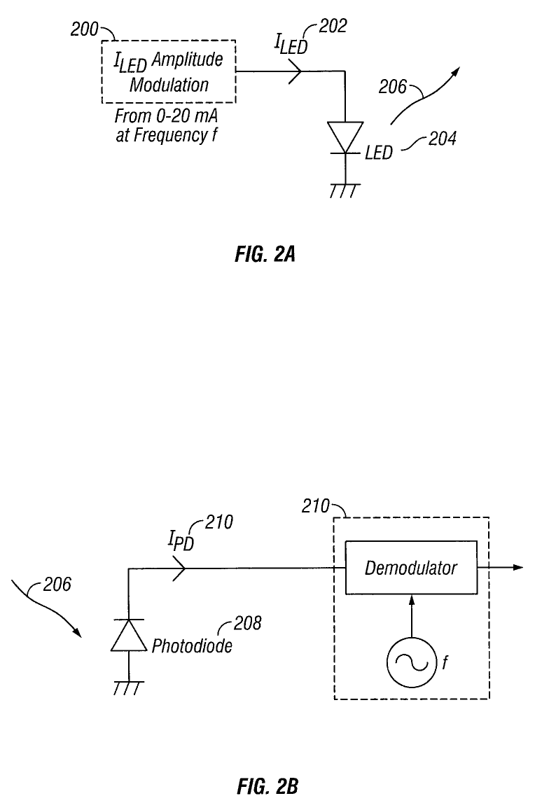

FIG. 2A is a circuit diagram illustrating exemplary logic for modulating LED current amplitude according to one embodiment of the present invention, while FIG. 2B is a circuit diagram illustrating exemplary logic for processing received signals 206 according to the embodiment depicted in FIG. 2A. At block 200 in FIG. 2A, the LED current amplitude is modulated from 0-20 mA at frequency f. The modulated LED current I_{LED} 202 is then fed to the LED 204. The LED 204 then generates the one or more electromagnetic signals 206.

Reflected electromagnetic signals 206 may then be detected by one or more photodiodes 208 situated within the display device. This is shown in FIG. 2B. In one embodiment, the photodiode 208 is adapted to convert the electromagnetic signals 206 into photodiode current I_{PD} 210. The photodiode current I_{PD} 210 is then fed to demodulation logic 210 adapted to process said current I_{PD} 210.

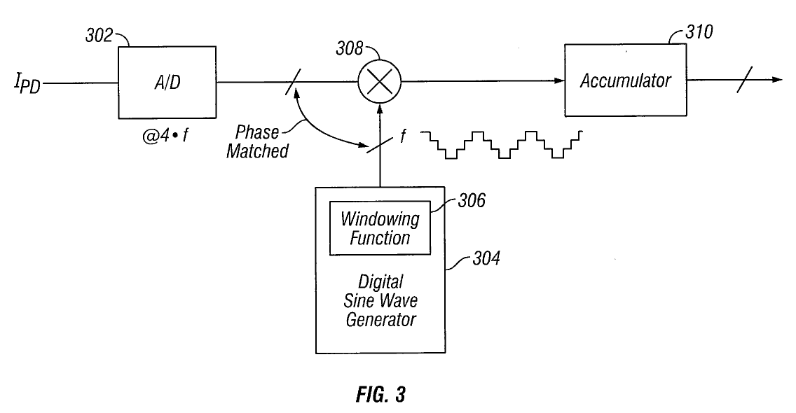

Various methods may be used to implement demodulation logic 210 according to embodiments of the present invention. For example, FIG. 3 is a circuit diagram illustrating exemplary demodulation logic 210 according to one embodiment of the present invention. As shown by FIG. 3, the photodiode current I_{PD} 210 is initially converted to a digital signal with an analog-to-digital (A/D) converter 302, preferably at a conversion rate at least 4 times the modulation frequency. In one embodiment, a 4 MHz conversion rate may be used.

The converted signal digital values may be multiplied by a reference digital sine wave at the same frequency as the LED modulation (at a fixed phase relationship), and the multiplication results summed up so as to form an accumulated result. As shown in the figure, a digital sine wave generator 304 may be used to generate the digital sine wave, a multiplier 308 may be used to multiply the digital values by the reference sine wave, and an accumulator 310 may be used for storing the result.

In order to optimally reject spurious noise on frequencies near the modulation/demodulation frequency, a windowing function 306 may be used to pre-process the reference digital sine wave so that the amplitude of the reference wave smoothly grows from zero to a maximal value and then smoothly declines back to zero at the end of the accumulation time. The fixed phase of the reference wave may be selected to maximize the phase match of the photocurrent signal and the reference wave, accounting for other system phase delays such as RC panel delay, amplifier delay, etc.

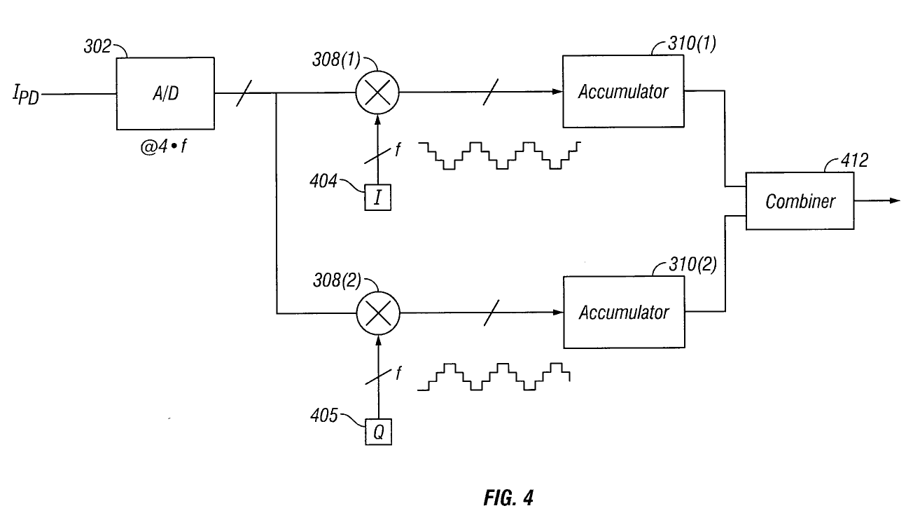

An alternative embodiment utilizes dual reference sine/cosine waves that exhibit a 90 degree phase relationship to each other. This is shown by FIG. 4. Dual multipliers 308(1) and 308(2) and accumulators 310(1) and 310(2) capture the in-phase and quadrature components of the photodiode signal (via reference waves generated by an in-phase generator 404 and a quadrature phase generator 405). Windowing functions (not shown) can be used to pre-process the reference waves in order to ensure spectral purity, as in the embodiment depicted by FIG. 3. The amplitude may then be determined by combining the in-phase and quadrature accumulated results in a combiner 412. According to one embodiment, the logic for combining the accumulated results is given by the following equation:

FinalAmplitude=((InPhaseresult)²+(Quadresult)²)^{1/2}

Note that this alternative embodiment does not require advance knowledge of the phase delays in the system, but requires additional hardware (e.g., dual reference waves, dual multipliers, dual accumulators, etc.).

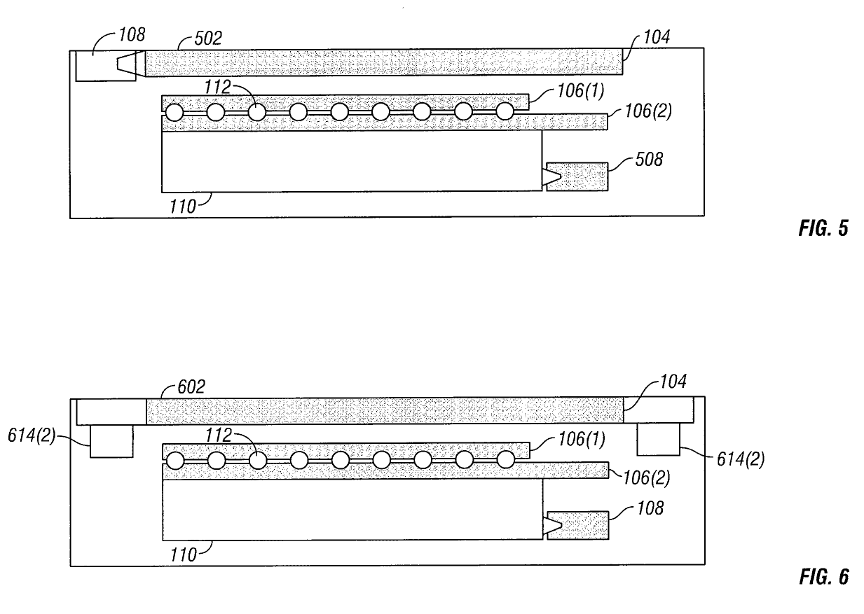

FIG. 5 is a block diagram illustrating an exemplary optical-in-liquid-crystal-display device 502 including a light source 108 situated adjacent to a cover glass 104 according to one embodiment of the present invention. As shown by the figure, the light source 108 is situated so as to sidelight the cover glass 104 instead of the backlight assembly of the display device 502. In some embodiments, this allows the electromagnetic signals to pass through the cover glass 104 without passing through the entire display structure (i.e., as between the two plates of thin film transistor glass 106(1) and 106(2)).

In some embodiments, a second light source 508 remains situated within the backlight assembly. This second light source 508 may be adapted to illuminate the display by transmitting light behind the display structure (for example, as via a white LED). Optionally, one or more lightguides 110 may be used to direct, position, control, manipulate, and/or reflect the electromagnetic signals such that the light signals are provided to the display structure.

FIG. 6 is a block diagram illustrating an exemplary optical-in-liquid-crystal-display device 602 adapted to detect force input according to one embodiment of the present invention. As shown by the figure, a plurality of force sensors 614(1) and 614(2) are coupled to opposite sides of the cover glass 104. The force sensors 614(1) and 614(2) are adapted to detect forces applied by the user upon the cover glass 104. In this manner, input to the display device 102 may be based upon the combination of detected electromagnetic signals (i.e., the optical input) and changes in detected force (i.e., the contact input).

The force sensors may be of any type, combination, or arrangement according to the embodiments of the present invention. This includes, without limitation, spring mass, piezo-film, strain gauge, surface-acoustic wave, optical, servo-force balance, and null-balance accelerometers. Additionally, the force sensors may be situated in any position relative to the cover glass 104 so as to detect the various forces exerted upon it by a user's finger, stylus, or other such pointing instrument.

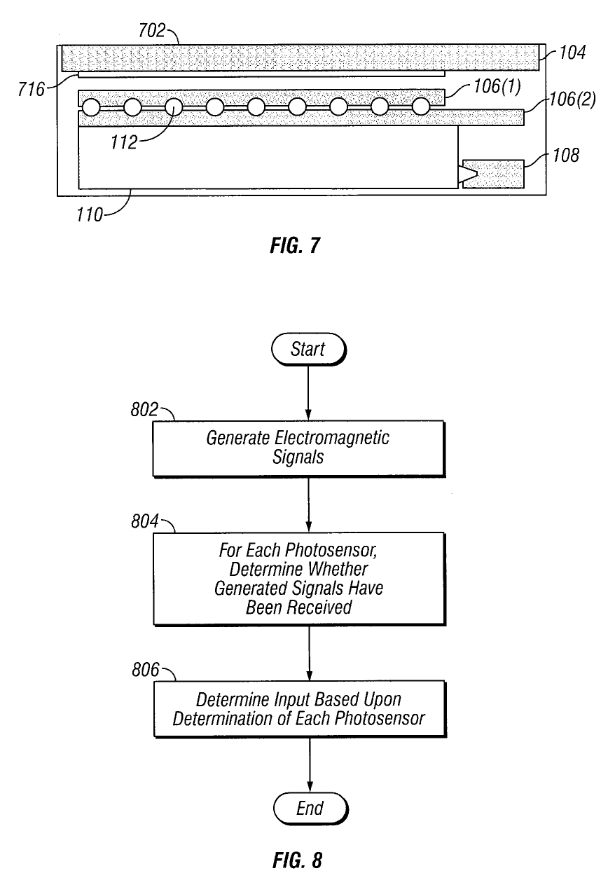

FIG. 7 is a block diagram illustrating an exemplary optical-in-liquid-crystal-display device 702 adapted to detect capacitive input according to one embodiment of the present invention. As shown by the figure, the display device 702 includes a sensor panel 716 positioned behind the cover glass 104 and adapted to detect touch input via capacitive sensing. In some embodiments, the sensor panel includes a plurality of row and column traces so as to indicate the position of the input stimulus based upon the specific sensors that have been driven. In one embodiment, a simple (unpatterned) capacitive sensor may be used in combination with an optical touch screen in order to detect and extract an exact touchdown time.

FIG. 8 is a flow diagram illustrating an exemplary method of determining input from received signals according to one embodiment of the present invention. At step 802, electromagnetic signals are generated. This may be accomplished, for example, via one or more LEDs and/or other light modules housed within a display device (e.g., behind an LCD display structure, adjacent to a cover glass, or situated in another location). The electromagnetic signals can be distinguishable from ambient signals in any number of ways. For example, in some embodiments, the electromagnetic signals generated are not within the spectrum of visible light. This includes, without limitation, microwave, infrared, and ultraviolet signals.

At step 804, each photosensor of a photosensor array determines whether the generated signals have been received at that respective photosensor. In some embodiments, the photosensors are situated so as to detect signals that have been reflected off of a user's finger, stylus, or other such pointing instrument.

At step 806, input location(s) may be determined based in part upon the individual determination of each photosensor as to whether the generated signals have been received. For example, if most of the photosensors servicing the upper right region of an optical input device report receipt of generated signals, input corresponding to that region may be passed to one or more software applications presently executing on the optical input device. Since the photosensors are detecting the presence of signals that are distinguishable from ambient signals, changes in ambient lighting will not affect the input mechanism of the device.

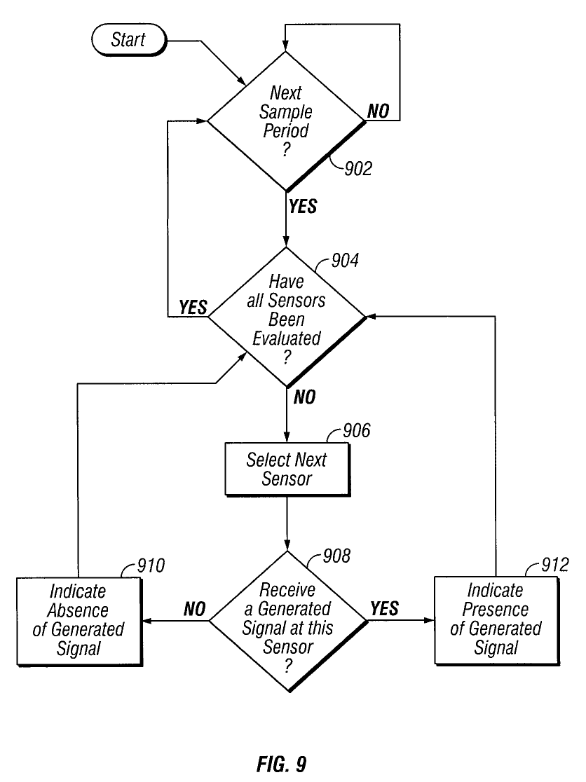

FIG. 9 is a flow diagram illustrating an exemplary method of sampling photosensors according to one embodiment of the present invention. At step 902, the system pauses for the next sample period. In some embodiments, the sample period may be adjusted so as to ensure adequate time for the processing of output from all of the photosensors. However, the sample period could be set to any period according to the embodiments of the present invention.

At step 904, the system determines whether all of the sensors have been evaluated for this sample period. If they have not, the next sensor is selected at step 906, and the system then determines whether a generated signal has been received at the selected sensor. If the signal has not been received, this is indicated at step 910. If the signal has been received, this is indicated at step 912. The process then repeats per step 904 until all sensors have been evaluated for this sample period. When this condition occurs, the process repeats per step 902.

Even though FIG. 9 depicts an iterative method of sensor determination, in other embodiments, at least a portion of the sensors may simultaneously report whether a generated signal has been received. In this manner, the process may be expedited so as to attain shorter sample periods and hence more responsive input detection. In some embodiments, only the sensors located in shaded regions (i.e., regions of the touch panel where ambient light levels are beneath a certain threshold) report whether a generated signal has been received.

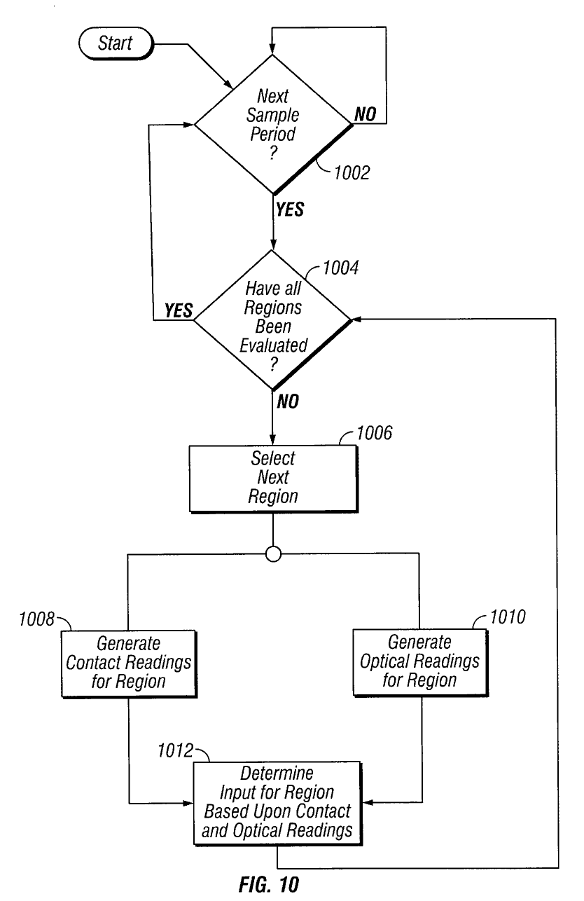

FIG. 10 is a flow diagram illustrating an exemplary method of determining input from optical readings and contact readings according to one embodiment of the present invention. At step 1002, the system pauses for the next sample period. At step 1004, the system determines whether all regions in a sensory area have been evaluated. In some embodiments, the regions are defined as combinations of specific photosensors and/or contact sensors (e.g., force sensors and/or capacitance sensors).

At step 1006, the next region is selected. Contact readings are generated for that region at step 1008 (i.e., readings associated with the contact sensors), while optical readings are generated for that region at step 1010 (i.e., readings associated with photosensors adapted to detect generated electromagnetic signals). At step 1012, the input for the region may be determined based upon both the contact and the optical readings. This allows some embodiments of the present invention to protect against false inputs generated by a detected optical signal without a detected force (e.g., as may be generated by a user's finger hovering close to the glass without actually contacting it), and generated by a detected force without a detected optical signal (e.g., as may be triggered by wind). After input for each region has been determined, the process repeats at step 1002.

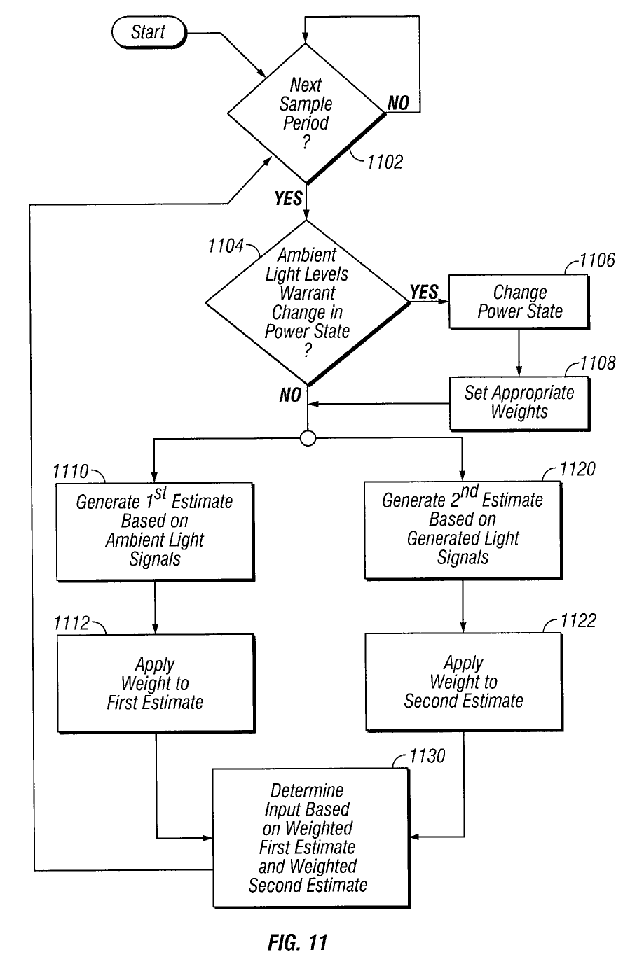

FIG. 11 is a flow diagram illustrating an exemplary method of optimizing power in an input device adapted to detect generated signals according to one embodiment of the present invention. At step 1102, the system pauses for the next sample period. At step 1104, the system determines whether the present ambient light levels warrant a change in the present power state of a modulated light source and/or array of photosensors. For example, if ambient lighting is sufficient, the power to these modules may be shut off at state 1106. If ambient lighting is not sufficient, the modules may be powered on at state 1106.

In some embodiments, a threshold may be defined based in part upon the amount of ambient light received at the photosensors relative to other photosensors during a given time period. Additionally, the threshold may be defined only when certain conditions exist. For example, in some embodiments, the threshold is defined when the amount of detected light is approximately uniform across all of the photosensors (e.g., a variance falls within a defined range). In some embodiments, the threshold may be used to determine whether the ambient lighting is sufficient for the purposes of step 1104.

As stated above, if a change in the power state is warranted, the state may be changed per step 1106. Additionally, the weight applied to generated signal detection and ambient light detection is recalibrated at step 1108. In embodiments where weights are based on factors other than the present power state of the device, step 1108 may occur even when the ambient light levels do not warrant a change in the present power state (i.e., after step 1104).

A first estimate of input based on ambient light signals is generated at step 1110 and correspondingly weighted at step 1112. Likewise, a second estimate of input based on generated light signals is generated at step 1120 and correspondingly weighted at step 1122. Finally, an input is determined based upon both of the weighted estimates at step 1130, and the process then repeats at step 1102.

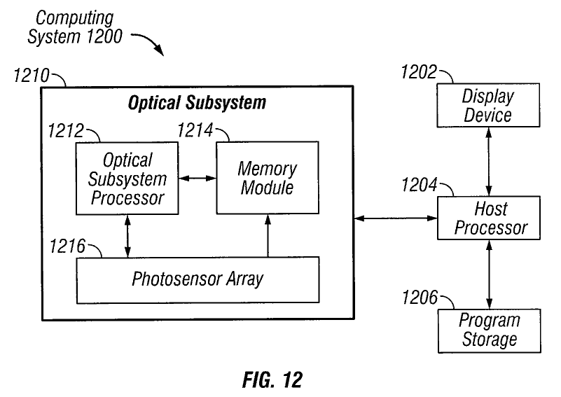

FIG. 12 is a block diagram illustrating an exemplary computing system 1200 that can include one or more of the embodiments of the invention described above. Computing system 1200 includes an optical subsystem 1210 adapted to process optical signals in order to determine user input. The optical subsystem 1210 can include, but is not limited to, an optical subsystem processor 1212, a memory module 1214, and a photosensor array 1216.

The memory module 1214 may include any type of module adapted to enable digital information to be stored, retained, and retrieved. Additionally, the memory module 1214 may comprise any combination of volatile and non-volatile storage devices, including without limitation RAM, DRAM, SRAM, ROM, and/or flash memory. Note also that the memory module 1214 may be organized in any number of architectural configurations, including, for example, registers, memory caches, data buffers, main memory, mass storage, and/or removable media.

The optical subsystem processor 1210 is adapted to execute sequences of instructions by loading and storing data to the memory module 1214. Possible instructions include, for example, instructions for determining user input based upon data generated from the photosensor array 1216. In some embodiments, the photosensor array 1216 includes a plurality of photosensors (e.g., infrared sensitive photodiodes) adapted to determine whether a specific electromagnetic signal has been received during a designated period. The photosensor array 1216 may also include a separate set of photosensors adapted to detect ambient signals.

In some embodiments, computing system 1200 includes a host processor 1204 for receiving outputs from the optical subsystem processor 1212 and for performing actions based on the outputs. These actions can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. The host processor 1204 can also perform additional functions that may not be related to input processing, and can be coupled to a program storage 1206 and a display device 1202 such as an LCD display for providing a UI to a user of the device.

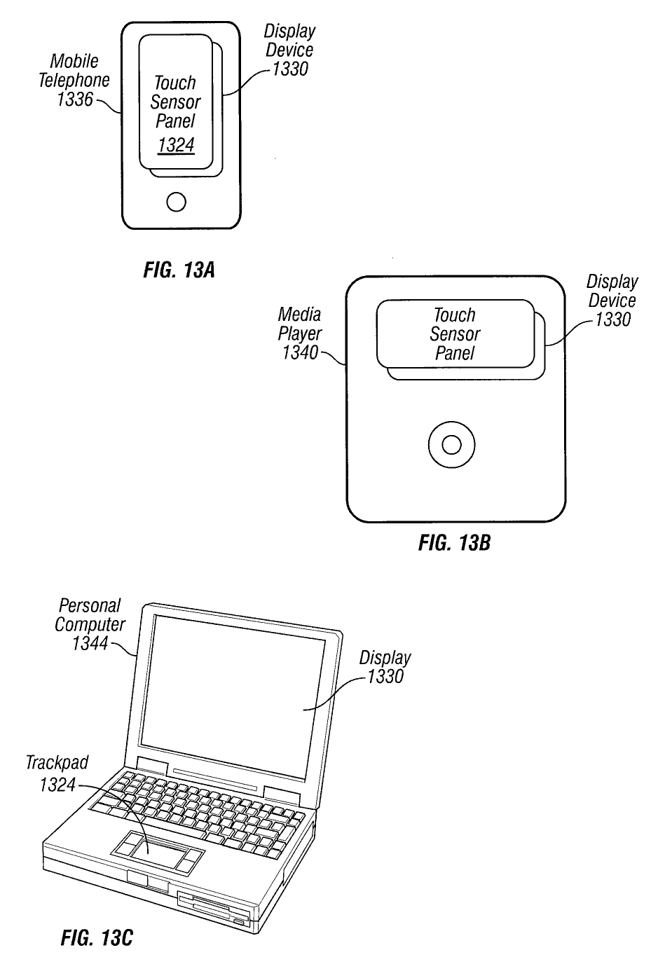

FIG. 13A illustrates an exemplary mobile telephone 1336 that can include photosensor array 1324 and display device 1330, the photosensor array 1324 adapted to detect reflected electromagnetic signals according to embodiments of the invention.

FIG. 13B illustrates exemplary digital media player 1340 that can include photosensor array 1324 and display device 1330, the photosensor array 1324 adapted to detect reflected electromagnetic signals according to embodiments of the invention.

FIG. 13C illustrates exemplary personal computer 1344 that can include photosensor array (trackpad) 1324 and display 1330, the photosensor array and/or display adapted to detect reflected electromagnetic signals according to embodiments of the present invention. The mobile telephone, media player and personal computer of FIGS. 13A, 13B, and 13C can achieve improved input recognition by utilizing photosensors adapted to detect generated electromagnetic signals according to embodiments of the invention.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. An apparatus for sensing touch and proximity events in a display device, comprising:
an optical transmitter adapted to transmit an electromagnetic signal through a first plane of the display device, the optical transmitter being in addition to a main light source for the display device; and
an optical receiver adapted to detect the electromagnetic signal as reflected back through said first plane.

2. The apparatus of claim 1, wherein a portion of the first plane is comprised within a backlight assembly of the display device.

3. The apparatus of claim 1, wherein the electromagnetic signal comprises a wavelength that is outside the spectrum of visible light.

4. The apparatus of claim 1, wherein the electromagnetic signal comprises a modulated electromagnetic signal within the spectrum of visible light.

5. The apparatus of claim 1, wherein the optical receiver is positioned so as to minimize exposure to electromagnetic signals propagating in one direction.

6. The apparatus of claim 1, wherein a cover glass of the display device forms at least a portion of the first plane.

7. The apparatus of claim 1 further comprising a force sensor adapted to detect a force exerted upon a surface of the display device, wherein at least one output from the display device is based upon an output from the force sensor.

8. The apparatus of claim 1 further comprising a touch sensor, wherein output from the display device is based upon a weighted output from the touch sensor and a weighted output from the optical receiver.

9. The apparatus of claim 1, wherein the optical receiver comprises an infrared-sensitive photodiode.

10. The apparatus of claim 1, further comprising:
a sensor adapted to detect a level of ambient light; and
a power controller adapted to vary an amount of power supplied to the optical transmitter based at least in part upon the level of ambient light.

11. The apparatus of claim 10, wherein the power controller is adapted to vary the amount of power supplied to the optical transmitter at a touch-screen sampling frequency associated with the display device.

12. A method comprising:
generating electromagnetic signals at a first location within a device adapted for optical input;
modulating the electromagnetic signals so as to attain a level of insensitivity to ambient signals;
determining whether a reflected modulated electromagnetic signal has been received at a second location within the optical device; and
generating an output based at least in part upon said determining whether the reflected modulated electromagnetic signal has been received at the second location.

13. The method of claim 12, wherein the electromagnetic signals comprise wavelengths that are outside the spectrum of visible light.

14. The method of claim 12, wherein the electromagnetic signals comprise wavelengths that are within the spectrum of visible light.

15. The method of claim 12, wherein the first location comprises an area adjacent to a cover glass of the device.

16. The method of claim 12, wherein the first location comprises a backlight assembly of the device.

17. The method of claim 12, wherein the device adapted for optical input is further adapted to detect contact with a touch panel via one or more capacitive sensors.

18. The method of claim 12, wherein the device adapted for optical input is further adapted to detect contact with a touch panel via one or more force sensors.

19. The method of claim 12, wherein said modulating the electromagnetic signals comprises modulating the electromagnetic signals in a 20 KHz to 1 MHZ range.

20. The method of claim 12, wherein the level of insensitivity comprises first order insensitivity.

21. The method of claim 12, wherein the second location comprises a photosensor that is oriented so as to minimize exposure to electromagnetic signals propagating in one direction.

22. The method of claim 12, wherein the second location comprises an infrared sensitive photodiode.

23. A mobile phone comprising:
an optical transmitter adapted to transmit an electromagnetic signal through a first plane of a display associated with the mobile phone, the optical transmitter being in addition to a main light source for the display; and
an optical receiver adapted to detect the electromagnetic signal as reflected back through said first plane.

24. A digital media player comprising:
an optical transmitter adapted to transmit an electromagnetic signal through a first plane of a display associated with the digital media player, the optical transmitter being in addition to a main light source for the display; and
an optical receiver adapted to detect the electromagnetic signal as reflected back through said first plane.

25. A personal computer comprising:
an optical transmitter adapted to transmit an electromagnetic signal through a first plane of a display associated with the personal computer, the optical transmitter being in addition to a main light source for the display; and
an optical receiver adapted to detect the electromagnetic signal as reflected back through said first plane.
